(19) United States
(12) Patent Application Publication
(10) Pub. No.: US 2022/0108168 A1
(43) Pub. Date: Apr. 7, 2022

(54) FACTORIZED NEURAL NETWORK

(71) Applicant: Microsoft Technology Licensing, LLC, Redmond, WA (US)

(72) Inventors: Nicolo FUSI, Watertown, MA (US); Mikhail KHODAK, Hatfield, PA (US); Neil Arturo TENENHOLTZ, Cambridge, MA (US); Lester Wayne MACKEY, II, Arlington, MA (US)

(73) Assignee: Microsoft Technology Licensing, LLC, Redmond, WA (US)

(21) Appl. No.: 17/109,824

(22) Filed: Dec. 2, 2020

Related U.S. Application Data
(60) Provisional application No. 63/087,018, filed on Oct. 2, 2020.

(51) Int. Cl. G06N 3/08; G06K 9/62; G06F 17/16

(52) U.S. Cl. CPC G06N 3/08; G06F 17/16; G06K 9/626

(57) ABSTRACT

Aspects of the present disclosure relate to factorized neural network techniques. In examples, a layer of a machine learning model is factorized and initialized using spectral initialization. For example, an initial layer parameterized using an initial matrix is processed such that it is instead parameterized by the product of two or more matrices, thereby resulting in a factorized machine learning model. An optimizer associated with the machine learning model may also be processed to adapt a regularizer accordingly. For example, a regularizer using a weight decay function may be adapted to instead use a Frobenius decay function with respect to the factorized model layer. The factorized machine learning model may be trained using the processed optimizer and subsequently used to generate inferences.

### CROSS-REFERENCE TO RELATED APPLICATION

This application claims priority to U.S. Provisional Application No. 63/087,018, titled “Factorized Neural Network,” filed on Oct. 2, 2020, the entire disclosure of which is hereby incorporated by reference in its entirety.

### BACKGROUND

The complexity of a machine learning model may cause training and using the model to consume a prohibitive or otherwise restrictive amount of computing resources. For example, complex neural network layers may require large amounts of memory and/or compute resources for training and generating inferences, among other examples.

It is with respect to these and other general considerations that embodiments have been described. Also, although relatively specific problems have been discussed, it should be understood that the embodiments should not be limited to solving the specific problems identified in the background.

### SUMMARY

Aspects of the present disclosure relate to factorized neural network techniques. In examples, a layer of a machine learning model is factorized and initialized using spectral initialization. For example, an initial layer parameterized using an initial matrix is processed such that it is instead parameterized by the product of two or more matrices, thereby resulting in a factorized machine learning model. An optimizer associated with the machine learning model may also be processed to adapt a regularizer accordingly. For example, a regularizer using a weight decay function may be adapted to instead use a Frobenius decay function with respect to the factorized model layer. The factorized machine learning model may be trained using the processed optimizer and subsequently used to generate inferences.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 illustrates an overview of an example system in which the factorized neural network techniques described herein are utilized.

FIG. 2 illustrates an overview of an example method for processing a machine learning model and an associated optimizer according to aspects of the present disclosure.

FIG. 3 illustrates an overview of an example method for utilizing remote model processing to generate and train a factorized machine learning model and associated optimizer.

FIG. 4 illustrates an overview of an example method for processing a machine learning model and an associated optimizer at a server device according to aspects of the present disclosure.

FIG. 5 is a block diagram illustrating example physical components of a computing device with which aspects of the disclosure may be practiced.

FIGS. 6A and 6B are simplified block diagrams of a mobile computing device with which aspects of the present disclosure may be practiced.

FIG. 7 is a simplified block diagram of a distributed computing system in which aspects of the present disclosure may be practiced.

FIG. 8 illustrates a tablet computing device for executing one or more aspects of the present disclosure.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

In examples, a neural network comprises one or more layers of matrix-parameterized transformations, which may be followed by operations such as activation or normalization. While such layers may contribute to model expressivity, they may also increase memory utilization and/or computational burden. In some instances, model compression techniques are used to reduce resource utilization in the inference phase. While such techniques may be applied to the machine learning model after the model is trained, resource utilization may still be problematic during the training phase. Additionally, applying model compression techniques prior to training may yield a model that is no longer effective or a model that fails to behave similarly to the uncompressed model (e.g., no longer converges to a similar solution), among other examples.

Accordingly, aspects of the present disclosure relate to factorized neural networks. A matrix-parameterized layer of a neural network may be factorized, thereby generating a layer that is instead parameterized by the product of two or more matrices. As compared to the initial matrix-parameterized layer, utilizing the resulting matrices reduces the associated computation and memory costs (e.g., when training or using the model). For example, factoring an initial matrix of dimensions m×n into matrices of dimensions m×r and n×r may reduce the resource utilization associated with the neural network layer from O(mn) to O(mr+nr).

As an example, a fully connected layer of a neural network may take an n-dimensional input xᵢ₋₁ and output an m-dimensional vector xᵢ=σ(Wxᵢ₋₁). Accordingly, the matrix W∈ [symbol] ^{m×n} may be decomposed into the product UV^{T}, where factorization matrix U∈ [symbol] ^{m×r} and factorization matrix V∈ [symbol] ^{n×r}. In other examples, an inner matrix M∈ [symbol] ^{r×r} is further included in the decomposition, such that W=UMV^{T}. Thus, it will be appreciated that a matrix-parameterized layer may be decomposed into any number of factorization matrices or, as another example, M may instead be a sequence of any number of inner matrices M₁, . . . , Mᵢ (e.g., of potentially square or non-square shape).

As another example, a convolutional layer may take an h×w×cᵢ₋₁-dimensional input and output an h×w×cᵢ-dimensional output xᵢ defined by convolving cᵢ filters of size k×k over each of the cᵢ₋₁ input channels. In such examples, the layer may be parameterized by a cᵢ×cᵢ₋₁×k×k tensor that may be reshaped into a cᵢk×cᵢ₋₁k matrix W. The matrix W may be decomposed into U×V^{T}, such that the tensor obtained by reshaping W may instead be computed using two convolutions using tensors obtained by reshaping U and V^{T}. Additionally, similar to the above fully connected example, one or more additional inner matrices M₁, . . . , Mᵢ maybe added to the decomposition.

As such, it will be appreciated that instant techniques are applicable to any of a variety of machine learning layer types (e.g., fully connected layers, convolutional layers, multi-head attention layers, etc.) and, additionally, need not be applied solely to matrices but may also be applied to Tucker decompositions or tensors, among other examples. In some instances, a machine learning model may comprise one or more layers that are pre-factored, such that they need not be factorized according to the above-described techniques. For example, a multi-head attention layer may be factored by definition, such that it need not be factorized prior to processing the multi-head attention layer according to the spectral initialization and Frobenius decay techniques discussed below.

Factorization matrices generated according to aspects described herein may be initialized using spectral initialization, which may use singular value decomposition (SVD) to ensure parameters of a product matrix of the factorization matrices are relatively close (e.g., in value, in magnitude, etc.) to parameters of the initial matrix (e.g., from which the factorization matrices were generated). Returning to the example factorization matrices above, spectral initialization of U and V may be performed such that U=Ũ\sqrt{Σ} and \tilde{V}=\sqrt{Σ}, where Ũ, Σ, \tilde{V}=SVDᵣ(W) and is obtained using the rank-r SVD of W. Thus, the factorization matrices may inherit the same or similar scaling properties as the non-factorized initial matrix. For example, spectral initialization may retain the largest singular values of W in UV^{T}.

In addition, an optimizer used to evaluate a non-factorized layer (e.g., that is parameterized using an initial matrix) may be adapted according to aspects disclosed herein in order to evaluate a factorized layer that is parameterized using multiple factorization matrices. An example optimizer may be of the following form:

$${min}_{θ ∈ Θ} \frac{1}{\vert S \vert} {Σ}_{( x , y ) ∈ S} ℓ ( {f}_{W} ( x ) , y ) + Ω ( θ )$$

In the above equation, f_{θ}: X [symbol] Y is a function from input domain X to output domain Y and is parameterized by elements θ∈Θ, [symbol] : Y×Y [symbol] [symbol] is a scalar-valued loss function, Ω: Θ [symbol] [symbol] is a scalar-valued regularizer, and S⊂X×Y is a finite set of training data. In a non-factorized example, an example regularizer Ω(θ) may be a weight decay function, such as

$$\frac{λ}{2} {\sum }_{W ∈ θ} {‖ W ‖}_{F}^{2}$$

for some λ≥0.

In examples where a layer is factorized according to aspects described herein, a weight decay function associated with the factorized layer may instead be replaced by a Frobenius decay function. An example Frobenius decay function based on parameters U∈ [symbol] ^{m×r}, V∈ [symbol] ^{n×r}, and M∈ [symbol] ^{r×r} is provided below:

$$Ω ( θ ) = \frac{λ}{2} {‖ U ( {\prod }_{j = 1}^{d} {M}_{j} ) {V}^{T} ‖}_{F}^{2}$$

As a result of replacing a weight decay function with a Frobenius decay function in a regularizer of the optimizer, the objective may not be substantially changed, such that a rank-r optimum of the non-factorized problem may also be an optimum of the factorized problem. It will be appreciated that while example equations are provided above, any of a variety of similar or alternative equations may be used according to aspects described herein.

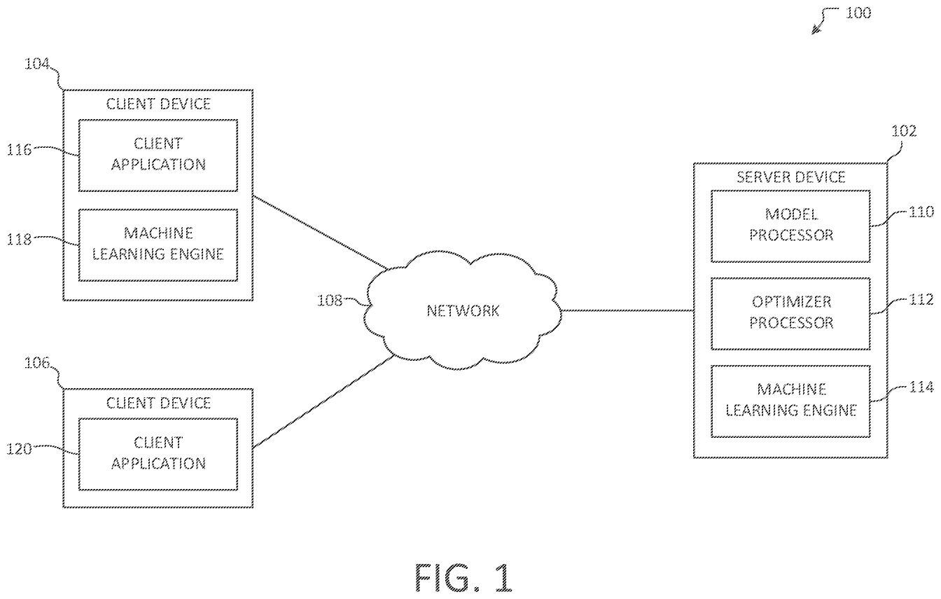

FIG. 1 illustrates an overview of an example system 100 in which the factorized neural network techniques described herein are utilized. As illustrated, system 100 comprises server device 102, client device 104, client device 106, and network 108. In examples, server device 102 and client devices 104 and 106 communicate using network 108, which may comprise a local area network, a wireless network, or the Internet, or any combination thereof, among other examples.

Server device 102 may be any of a variety of computing devices, including, but not limited to, a server computing device or a set of computing devices that form a distributed computing device. Similarly, client devices 104 and 106 may each be any of a variety of computing devices, including, but not limited to, a mobile computing device, a laptop computing device, a tablet computing device, or a desktop computing device. It will be appreciated that while system 100 is illustrated as comprising one server device 102 and two client devices 104 and 106, any number of such elements may be used in other examples. Further, the functionality described herein with respect to server device 102 and client devices 104 and 106 may be distributed among or otherwise implemented on any number of different computing devices in any of a variety of configurations in other examples. For example, model processor 110 and/or optimizer processor 112 need not be restricted to server device 102 and such aspects may alternatively or additionally be performed at client device 104 and/or client device 106.

Client device 104 is illustrated as comprising client application 116 and machine learning engine 118. Client application 116 may be any of a variety of applications, such as a web application executing in a web browser, a native application, or a combination thereof. For example, a user of client device 104 may use client application 116 to navigate to a website associated with server device 102 via which to provide a machine learning model and an associated machine learning model optimizer. In another example, client application 116 is part of a development environment. Client application 116 communicates with server device 102 to provide a non-factorized model and an associated optimizer. The model may be untrained. In response, client application 116 receives a factorized model and an associated processed optimizer. Machine learning engine 118 of client device 104 may train the factorized model using the processed optimizer in place of the non-factorized model and unprocessed optimizer. In examples, software code, application programming interface (API) calls, and other associated operations remain largely unchanged, aside from substituting the factorized model and processed optimizer for the non-factorized model and unprocessed optimizer. The trained factorized model may be used at client device 104 or may be provided to client device 106 for use by client application 120 to generate inferences.

Server device 102 is illustrated as comprising model processor 110, optimizer processor 112, and machine learning engine 114. In examples, server device 102 receives an indication of a non-factorized model and an unprocessed optimizer from a client device (e.g., client device 104). The indication may comprise a set of model processing rules. Example model processing rules include, but are not limited to, layer types and/or node types to be factorized or a depth above which or below which to process layers, among other examples. As another example, a model processing rule may specify a relative degree to which a layer should be factorized as compared to another layer, such that the compression of certain layers of a machine learning model may be prioritized over other layers. In some instances, a model processing rule may specify one or more constraints, such as a target amount of memory consumption or a target amount of compute utilization for the resulting factorized model.

Model processor 110 of server device 102 processes the non-factorized machine learning model associated with the indication that was received from client device 104. Model processor 110 performs the factorization and spectral initialization techniques described herein to generate a factorized model. In some examples, model processor 110 performs such aspects in view of one or more model processing rules (e.g., that may have been received from client device 104). For example, model processor 110 may traverse the machine learning model recursively in a depth-first fashion. Operations within the machine learning model may be replaced in-place with factorized operations accordingly. Thus, the resulting factorized machine learning model may comprise one or more non-factorized layers, factorized layers, and/or pre-factored layers. While example processing techniques are described herein, it will be appreciated that any of a variety of other techniques may be used to factorize a machine learning model. For example, the processing need not be depth-first and may instead be breadth-first, among other examples.

Optimizer processor 112 of server device 102 processes the unprocessed optimizer associated with the indication that was received from client device 104. In examples, optimizer processor 112 processes the optimizer according to the processing that was performed by model processor 110. For example, the regularizer of the optimizer may be adapted to address changes to layers of the resulting factorized model that were made by model processor 110. As described above, optimizer processor 112 may replace a weight decay function of a regularizer with a Frobenius decay function. Optimizer processor 112 may perform such aspects in view of one or more model processing rules or, as another example, may receive an indication from model processor 110 as to what changes were made to the non-factorized model when generating the factorized model, such that the resulting optimizer is generated according to such changes. It will be appreciated that all weight decay functions of a regularizer need not be replaced. For example, a regularizer may comprise both a weight decay function for a non-factorized layer and a Frobenius decay function for a factorized layer (or, in some examples, a Frobenius decay function for a non-factorized and/or pre-factored layer).

Server device 102 is illustrated as further comprising machine learning engine 114. In examples, server device 102 may train the factorized machine learning model (e.g., in addition to or as an alternative to machine learning engine 118 of client device 104). In some instances, an indication received from client device 104 further comprises a set of training data or a selection of a set of generic training data that is available to machine learning engine 114. For example, server device 102 may store or otherwise have access to one or more sets of image training data or sets textual training data, among other examples. Accordingly, machine learning engine 114 may train the factorized machine learning model (e.g., as was generated by model processor 110) using the processed optimizer (e.g., as was generated by optimizer processor 112). Server device 102 provides the factorized machine learning model (which, in some examples, has been trained by machine learning engine 114) and processed optimizer to client device 104.

In some instances, machine learning engine 114 is used to generate model processing rules in addition to or as an alternative to model processing rules that may be received from client device 104. For example, a model may be trained and subsequently used by server device 102 to generate a set of model processing rules based on an indication as to what the non-factorized model will be used for, a selection of a generic set of training data, and/or one or more constraints, among other examples. Thus, server device 102 may automatically refine the processing performed by model processor 110 and optimizer processor 112 in addition to or in the absence of model processing rules from client device 104.

As another example, server device 102 may provide a machine learning model service, whereby a machine learning model may be provided by client device 104 or 106, processed according to aspects of the present disclosure, and trained using a set of generic and/or provided training data (e.g., from the client device). The trained model may be provided to the client device for use. As another example, the trained model may be retained by server device 102 and used to generate inferences accordingly. Thus, aspects of the present disclosure and associated machine learning techniques need not be implemented at a client device, but may instead be implemented by server device 102 in order to provide such a machine learning model service.

As noted above, model processor 110 and optimizer processor 112 need not be limited to server device 102. For example, such functionality may instead be implemented by client device 104, thereby enabling local processing of machine learning models and associated optimizers according to aspects described herein. In other examples, a factorized machine learning model need not be trained using the same device on which it was generated and may instead be transmitted to another device (e.g., client device 106) for subsequent training and use. As another example, a factorized machine learning model may be initially trained after such processing (e.g., at client device 104) and may be subsequently retrained at another device (e.g., client device 106).

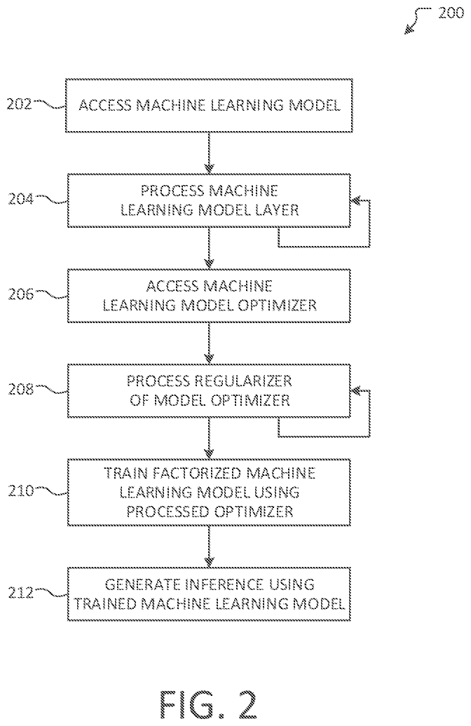

FIG. 2 illustrates an overview of an example method 200 for processing a machine learning model and an associated optimizer according to aspects of the present disclosure. In examples, aspects of method 200 are performed by a client device (e.g., client device 102 or 104 in FIG. 1) or a server device (e.g., server device 102).

Method 200 begins at operation 202, where a machine learning model is accessed. The machine learning model may not be trained and may be non-factorized. In examples, the machine learning model is accessed from local storage or may be accessed or otherwise received from a remote computing device, among other examples. As another example, the machine learning model may be in a form that renders it difficult or impossible to train, as the computational requirements associated with the model may be greater than the computational resources that are available.

Flow progresses to operation 204, where a layer of the machine learning model is processed according to aspects described herein. The layer of the machine learning model is factorized to generate a set of factorization matrices from an initial matrix, which are initialized according to the spectral initialization techniques discussed above. In other examples, the layer may be pre-factored, such that the disclosed factorization techniques need not be performed at operation 204 for the pre-factored layer. In examples, aspects of operation 204 are performed by a model processor, such as model processor 110 in FIG. 1. In some examples, operation 204 is performed according to one or more model processing rules, such that the layer processed at operation 204 is identified according to the set of model processing rules. Additionally, factorization performed at operation 204 may be performed based at least in part on one or more constraints, such as a target amount of memory consumption or a target amount of compute utilization. An arrow is illustrated from operation 204 that returns to operation 204 to illustrate that any number of machine learning model layers may be processed at operation 204.

Flow progresses to operation 206, where a machine learning model optimizer is accessed. In examples, the machine learning model optimizer is accessed from local storage or may be accessed or otherwise received from a remote computing device, among other examples. The machine learning model optimizer may be associated with the machine learning model that was accessed at operation 202.

At operation 208, the regularizer of the machine learning model optimizer is processed according to aspects described herein. In examples, aspects of operation 208 are performed by an optimizer processor, such as optimizer processor 112 in FIG. 1. As discussed above, the regularizer of the machine learning model optimizer is adapted to replace a weight decay function of the regularizer with a Frobenius decay function. Aspects of operation 208 may be performed in view of one or more model processing rules or, as another example, based at least in part on the processing that was performed at operation 204 (e.g., relating to changes that were made to the non-factorized model when generating the factorized model). An arrow is illustrated from operation 208 that returns to operation 208 to illustrate that an optimizer may be processed multiple times according to aspects described herein.

Moving to operation 210, the factorized machine learning model is trained using the processed optimizer. Aspects of operation 210 may be performed by a machine learning engine, such as machine learning engine 114 or 118 in FIG. 1. As noted above, operations associated with the factorized machine learning model such as training and using the model may remain largely unchanged by virtue of adapting the optimizer to the factorized machine learning model. For example, software code and API calls may be substantially similar to those associated with the non-factorized model, aside from substituting the factorized model and processed optimizer for the non-factorized model and unprocessed optimizer. The factorized machine learning model may be trained using a set of training data. As compared to the non-factorized model (e.g., that was accessed at operation 202), training the factorized machine learning model may exhibit reduced resource utilization.

Flow progresses to operation 212, where an inference is generated using the trained factorized machine learning model. Similar to training at operation 210, the factorized machine learning model may exhibit reduced resource utilization when generating inferences. Flow terminates at operation 212.

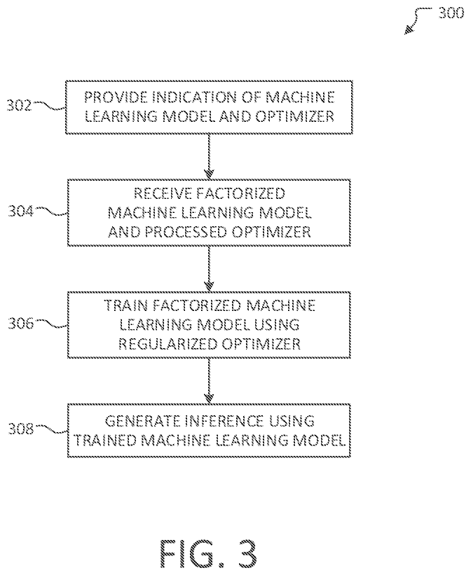

FIG. 3 illustrates an overview of an example method 300 for utilizing remote model processing to generate and train a factorized machine learning model and associated optimizer. In examples, aspects of method 300 are performed by a client device, such as client device 104 or client device 106 in FIG. 1.

Method 300 begins at operation 302, where an indication of a machine learning model and a machine learning model optimizer is provided. For example, the indication may be provided to a server device, such as server device 102 in FIG. 1. In examples, the indication comprises the machine learning model and the machine learning model optimizer. As another example, the indication may comprise references to the machine learning model and/or the machine learning model optimizer. In some instances, the indication comprises a set of model processing rules.

Flow progresses to operation 304, where a factorized machine learning model and a processed optimizer are received. The factorized machine learning model and processed optimizer may be received from a server device, such as server device 102 in FIG. 1. In some examples, operation 304 comprises receiving the model and optimizer or, as another example, references to the model and optimizer are received and subsequently used to access the machine learning model and/or optimizer accordingly.

At operation 306, the factorized machine learning model is trained using the processed optimizer. Aspects of operation 306 may be performed by a machine learning engine, such as machine learning engine 114 or 118 in FIG. 1. As noted above, operations associated with the factorized machine learning model such as training and using the model may remain largely unchanged by virtue of adapting the optimizer to the factorized machine learning model. For example, software code and API calls may be substantially similar to those associated with the non-factorized model, aside from substituting the factorized model and processed optimizer for the non-factorized model and unprocessed optimizer. The factorized machine learning model may be trained using a set of training data. As compared to the non-factorized model, training the factorized machine learning model may exhibit reduced resource utilization.

Flow progresses to operation 308, where an inference is generated using the trained factorized machine learning model. For example, a set of model inputs may be processed by the machine learning model to generate one or more outputs according to aspects of machine learning techniques. Similar to training at operation 306, the factorized machine learning model may exhibit reduced resource utilization when generating inferences. Flow terminates at operation 308.

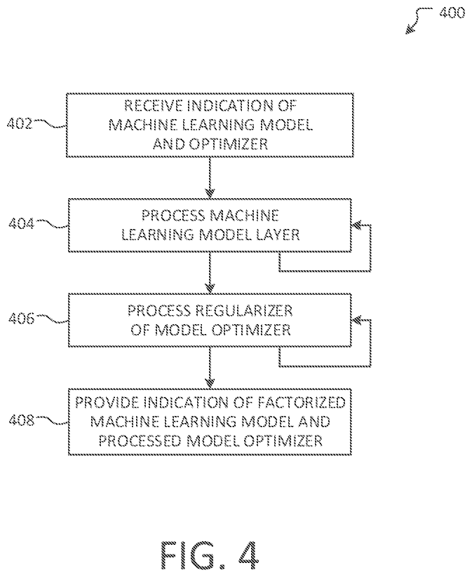

FIG. 4 illustrates an overview of an example method 400 for processing a machine learning model and an associated optimizer at a server device according to aspects of the present disclosure. In examples, aspects of method 400 are performed by a server device, such as server device 102 in FIG. 1.

Method 400 begins at operation 402, where an indication of a machine learning model and a machine learning model optimizer is received. The indication may be received from a client device, such as client device 104 or client device 106 in FIG. 1. In examples, the indication comprises the machine learning model and the machine learning model optimizer. As another example, the indication may comprise a reference to the machine learning model and/or the machine learning model optimizer. In some instances, the indication comprises a set of model processing rules. In examples, the machine learning model is an untrained machine learning model and may be non-factorized.

Flow progresses to operation 404, where a layer of the machine learning model is processed according to aspects described herein. The layer of the machine learning model is factorized to generate a set of factorization matrices from an initial matrix, which are initialized according to the spectral initialization techniques discussed above. In examples, aspects of operation 404 are performed by a model processor, such as model processor 110 in FIG. 1. In some examples, operation 404 is performed according to one or more model processing rules (e.g., as may have been received at operation 402), such that the layer processed at operation 404 is identified according to the set of model processing rules. Additionally, the factorization performed at operation 404 may be performed based at least in part on one or more constraints, such as a target amount of memory consumption or a target amount of compute utilization. An arrow is illustrated from operation 404 that returns to operation 404 to illustrate that any number of machine learning model layers may be processed at operation 404.

Eventually, flow progresses to operation 406, where the regularizer of the machine learning model optimizer is processed according to aspects described herein. In examples, aspects of operation 406 are performed by an optimizer processor, such as optimizer processor 112 in FIG. 1. As discussed above, the regularizer of the machine learning model optimizer is adapted to replace a weight decay function of the regularizer with a Frobenius decay function. Aspects of operation 406 may be performed in view of one or more model processing rules or, as another example, based at least in part on the processing that was performed at operation 404 (e.g., relating to changes that were made to the non-factorized model when generating the factorized model). An arrow is illustrated from operation 406 that returns to operation 406 to illustrate that an optimizer may be processed multiple times according to aspects described herein.

At operation 408, an indication of the factorized machine learning model and processed model optimizer is provided. The indication may be provided to the client device from which an indication was received at operation 402. In examples, the indication comprises the machine learning model and the machine learning model optimizer or, in other examples, the indication comprises references to the model and/or optimizer. Accordingly, the client device may train and utilize the factorized machine learning model as described above (e.g., according to aspects of operations 306 and 308 of FIG. 3). Flow terminates at operation 408.

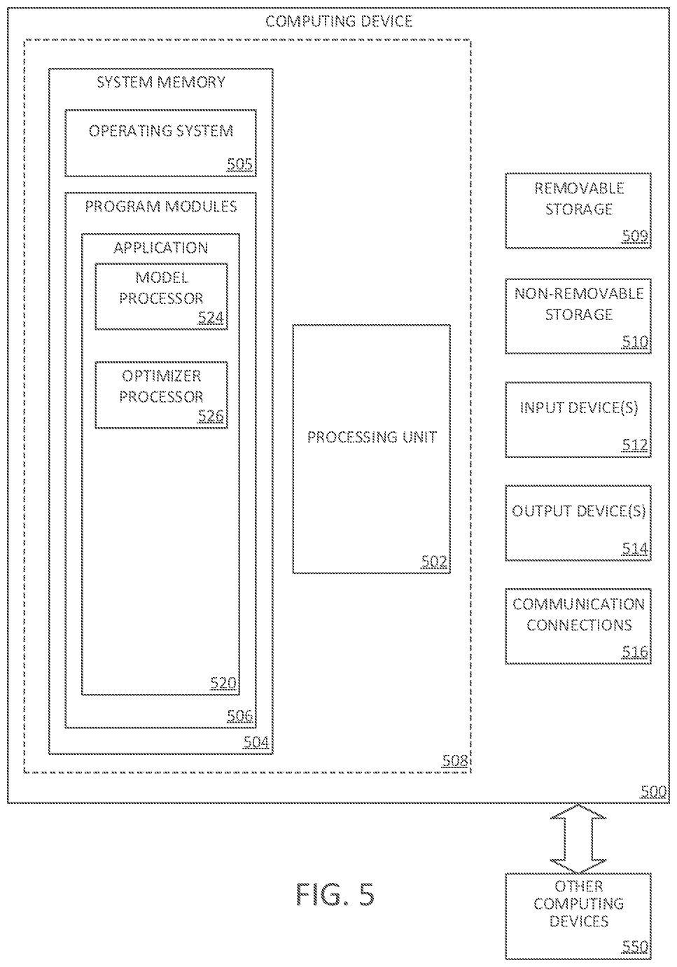

FIGS. 5-8 and the associated descriptions provide a discussion of a variety of operating environments in which aspects of the disclosure may be practiced. However, the devices and systems illustrated and discussed with respect to FIGS. 5-8 are for purposes of example and illustration and are not limiting of a vast number of computing device configurations that may be utilized for practicing aspects of the disclosure, described herein.

FIG. 5 is a block diagram illustrating physical components (e.g., hardware) of a computing device 500 with which aspects of the disclosure may be practiced. The computing device components described below may be suitable for the computing devices described above, including devices 102, 104, and 106 in FIG. 1. In a basic configuration, the computing device 500 may include at least one processing unit 502 and a system memory 504. Depending on the configuration and type of computing device, the system memory 504 may comprise, but is not limited to, volatile storage (e.g., random access memory), non-volatile storage (e.g., read-only memory), flash memory, or any combination of such memories.

The system memory 504 may include an operating system 505 and one or more program modules 506 suitable for running software application 520, such as one or more components supported by the systems described herein. As examples, system memory 504 may store model processor 524 and optimizer processor 526. The operating system 505, for example, may be suitable for controlling the operation of the computing device 500.

Furthermore, embodiments of the disclosure may be practiced in conjunction with a graphics library, other operating systems, or any other application program and is not limited to any particular application or system. This basic configuration is illustrated in FIG. 5 by those components within a dashed line 508. The computing device 500 may have additional features or functionality. For example, the computing device 500 may also include additional data storage devices (removable and/or non-removable) such as, for example, magnetic disks, optical disks, or tape. Such additional storage is illustrated in FIG. 5 by a removable storage device 509 and a non-removable storage device 510.

As stated above, a number of program modules and data files may be stored in the system memory 504. While executing on the processing unit 502, the program modules 506 (e.g., application 520) may perform processes including, but not limited to, the aspects, as described herein. Other program modules that may be used in accordance with aspects of the present disclosure may include electronic mail and contacts applications, word processing applications, spreadsheet applications, database applications, slide presentation applications, drawing or computer-aided application programs, etc.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 5 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 500 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

The computing device 500 may also have one or more input device(s) 512 such as a keyboard, a mouse, a pen, a sound or voice input device, a touch or swipe input device, etc. The output device(s) 514 such as a display, speakers, a printer, etc. may also be included. The aforementioned devices are examples and others may be used. The computing device 500 may include one or more communication connections 516 allowing communications with other computing devices 550. Examples of suitable communication connections 516 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 504, the removable storage device 509, and the non-removable storage device 510 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 500. Any such computer storage media may be part of the computing device 500. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

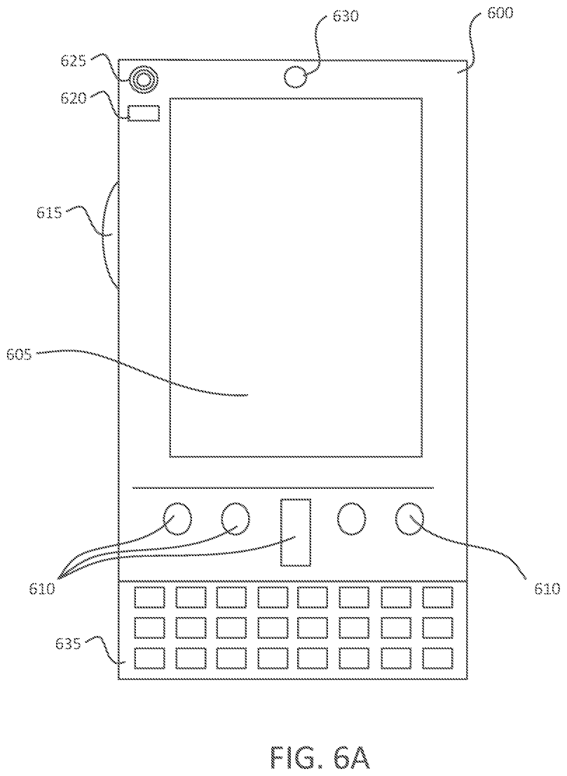

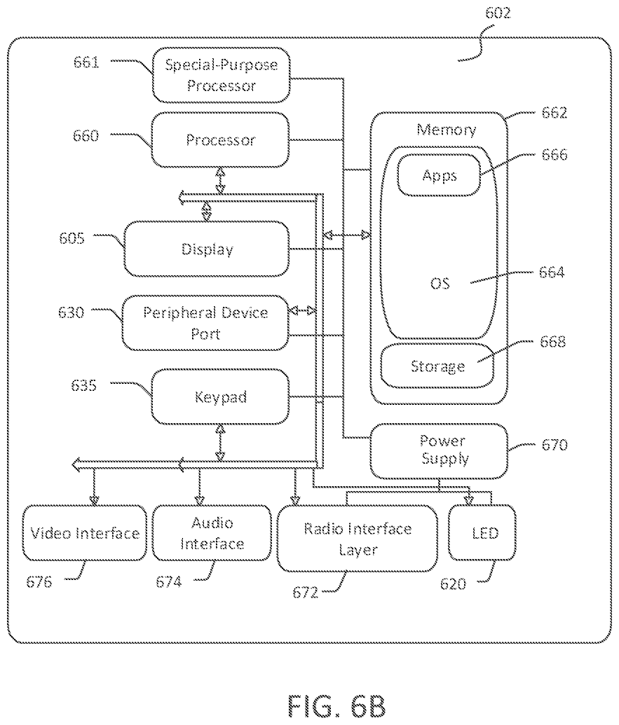

FIGS. 6A and 6B illustrate a mobile computing device 600, for example, a mobile telephone, a smart phone, wearable computer (such as a smart watch), a tablet computer, a laptop computer, and the like, with which embodiments of the disclosure may be practiced. In some aspects, the client may be a mobile computing device. With reference to FIG. 6A, one aspect of a mobile computing device 600 for implementing the aspects is illustrated. In a basic configuration, the mobile computing device 600 is a handheld computer having both input elements and output elements. The mobile computing device 600 typically includes a display 605 and one or more input buttons 610 that allow the user to enter information into the mobile computing device 600. The display 605 of the mobile computing device 600 may also function as an input device (e.g., a touch screen display).

If included, an optional side input element 615 allows further user input. The side input element 615 may be a rotary switch, a button, or any other type of manual input element. In alternative aspects, mobile computing device 600 may incorporate more or less input elements. For example, the display 605 may not be a touch screen in some embodiments.

In yet another alternative embodiment, the mobile computing device 600 is a portable phone system, such as a cellular phone. The mobile computing device 600 may also include an optional keypad 635. Optional keypad 635 may be a physical keypad or a “soft” keypad generated on the touch screen display.

In various embodiments, the output elements include the display 605 for showing a graphical user interface (GUI), a visual indicator 620 (e.g., a light emitting diode), and/or an audio transducer 625 (e.g., a speaker). In some aspects, the mobile computing device 600 incorporates a vibration transducer for providing the user with tactile feedback. In yet another aspect, the mobile computing device 600 incorporates input and/or output ports, such as an audio input (e.g., a microphone jack), an audio output (e.g., a headphone jack), and a video output (e.g., a HDMI port) for sending signals to or receiving signals from an external device.

FIG. 6B is a block diagram illustrating the architecture of one aspect of a mobile computing device. That is, the mobile computing device 600 can incorporate a system (e.g., an architecture) 602 to implement some aspects. In one embodiment, the system 602 is implemented as a “smart phone” capable of running one or more applications (e.g., browser, e-mail, calendaring, contact managers, messaging clients, games, and media clients/players). In some aspects, the system 602 is integrated as a computing device, such as an integrated personal digital assistant (PDA) and wireless phone.

One or more application programs 666 may be loaded into the memory 662 and run on or in association with the operating system 664. Examples of the application programs include phone dialer programs, e-mail programs, personal information management (PIM) programs, word processing programs, spreadsheet programs, Internet browser programs, messaging programs, and so forth. The system 602 also includes a non-volatile storage area 668 within the memory 662. The non-volatile storage area 668 may be used to store persistent information that should not be lost if the system 602 is powered down. The application programs 666 may use and store information in the non-volatile storage area 668, such as e-mail or other messages used by an e-mail application, and the like. A synchronization application (not shown) also resides on the system 602 and is programmed to interact with a corresponding synchronization application resident on a host computer to keep the information stored in the non-volatile storage area 668 synchronized with corresponding information stored at the host computer. As should be appreciated, other applications may be loaded into the memory 662 and run on the mobile computing device 600 described herein (e.g., search engine, extractor module, relevancy ranking module, answer scoring module, etc.).

The system 602 has a power supply 670, which may be implemented as one or more batteries. The power supply 670 might further include an external power source, such as an AC adapter or a powered docking cradle that supplements or recharges the batteries.

The system 602 may also include a radio interface layer 672 that performs the function of transmitting and receiving radio frequency communications. The radio interface layer 672 facilitates wireless connectivity between the system 602 and the “outside world,” via a communications carrier or service provider. Transmissions to and from the radio interface layer 672 are conducted under control of the operating system 664. In other words, communications received by the radio interface layer 672 may be disseminated to the application programs 666 via the operating system 664, and vice versa.

The visual indicator 620 may be used to provide visual notifications, and/or an audio interface 674 may be used for producing audible notifications via the audio transducer 625. In the illustrated embodiment, the visual indicator 620 is a light emitting diode (LED) and the audio transducer 625 is a speaker. These devices may be directly coupled to the power supply 670 so that when activated, they remain on for a duration dictated by the notification mechanism even though the processor 660 and other components might shut down for conserving battery power. The LED may be programmed to remain on indefinitely until the user takes action to indicate the powered-on status of the device. The audio interface 674 is used to provide audible signals to and receive audible signals from the user. For example, in addition to being coupled to the audio transducer 625, the audio interface 674 may also be coupled to a microphone to receive audible input, such as to facilitate a telephone conversation. In accordance with embodiments of the present disclosure, the microphone may also serve as an audio sensor to facilitate control of notifications, as will be described below. The system 602 may further include a video interface 676 that enables an operation of an on-board camera 630 to record still images, video stream, and the like.

A mobile computing device 600 implementing the system 602 may have additional features or functionality. For example, the mobile computing device 600 may also include additional data storage devices (removable and/or non-removable) such as, magnetic disks, optical disks, or tape. Such additional storage is illustrated in FIG. 6B by the non-volatile storage area 668.

Data/information generated or captured by the mobile computing device 600 and stored via the system 602 may be stored locally on the mobile computing device 600, as described above, or the data may be stored on any number of storage media that may be accessed by the device via the radio interface layer 672 or via a wired connection between the mobile computing device 600 and a separate computing device associated with the mobile computing device 600, for example, a server computer in a distributed computing network, such as the Internet. As should be appreciated such data/information may be accessed via the mobile computing device 600 via the radio interface layer 672 or via a distributed computing network. Similarly, such data/information may be readily transferred between computing devices for storage and use according to well-known data/information transfer and storage means, including electronic mail and collaborative data/information sharing systems.

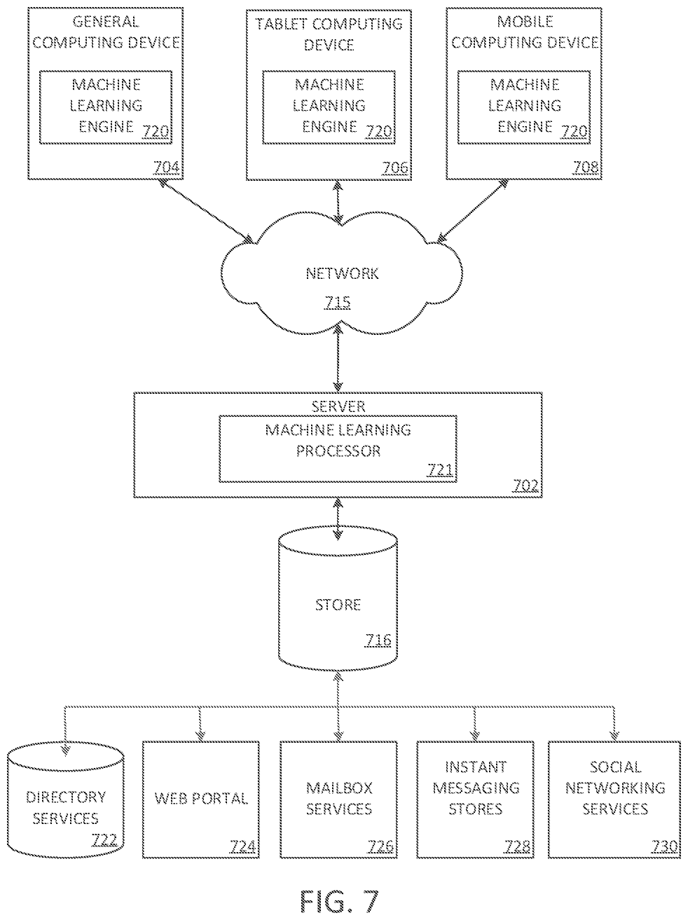

FIG. 7 illustrates one aspect of the architecture of a system for processing data received at a computing system from a remote source, such as a personal computer 704, tablet computing device 706, or mobile computing device 708, as described above. Content displayed at server device 702 may be stored in different communication channels or other storage types. For example, various documents may be stored using a directory service 722, a web portal 724, a mailbox service 726, an instant messaging store 728, or a social networking site 730.

A machine learning engine 720 may be employed by a client that communicates with server device 702, and/or machine learning processor 721 (e.g., performing aspects similar to those of model processor 110 and optimizer processor 112 in FIG. 1) may be employed by server device 702. The server device 702 may provide data to and from a client computing device such as a personal computer 704, a tablet computing device 706 and/or a mobile computing device 708 (e.g., a smart phone) through a network 715. By way of example, the computer system described above may be embodied in a personal computer 704, a tablet computing device 706 and/or a mobile computing device 708 (e.g., a smart phone). Any of these embodiments of the computing devices may obtain content from the store 716, in addition to receiving graphical data useable to be either pre-processed at a graphic-originating system, or post-processed at a receiving computing system.

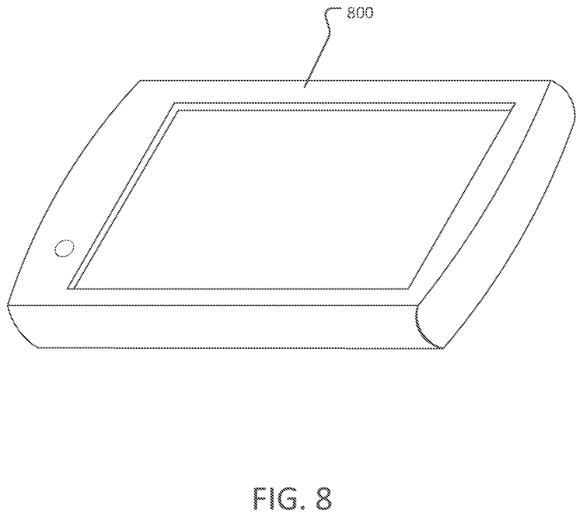

FIG. 8 illustrates an exemplary tablet computing device 800 that may execute one or more aspects disclosed herein. In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

As will be understood from the foregoing disclosure, one aspect of the technology relates to a system comprising: at least one processor; and memory storing instructions that, when executed by the at least one processor, causes the system to perform a set of operations. The set of operations comprises: processing a layer of an initial machine learning model to generate a factorized machine learning model; processing, based at least in part on the factorized machine learning model, an optimizer associated with the machine learning model to generate a processed optimizer associated with the factorized machine learning model; and training the factorized machine learning model using the processed optimizer. In an example, processing the layer of the initial machine learning model comprises: factoring a matrix associated with the layer of the initial machine learning model into a set of factorization matrices; and initializing the set of factorization matrices using spectral initialization. In another example, processing the optimizer comprises replacing a weight decay function of a regularizer with a Frobenius decay function. In a further example, the processed optimizer further comprises a weight decay function associated with a non-factorized layer of the factorized machine learning model. In yet another example, the layer is one of: a convolutional layer; a fully connected layer; or a multi-head attention layer. In a further still example, the initial machine learning model is processed to generate the factorized machine learning model based at least in part on a set of model processing rules. In another example, the layer of the initial machine learning model is a matrix-parameterized layer; and the set of factorization matrices are based at least in part on the matrix-parameterized layer.

In another aspect, the technology relates to a system comprising: at least one processor; and memory storing instructions that, when executed by the at least one processor, causes the system to perform a set of operations. The set of operations comprises: providing, to a server device, an indication of an untrained machine learning model and a machine learning optimizer; receiving, from the server device, a factorized machine learning model and a processed machine learning optimizer; and generating an inference using the trained factorized machine learning model. In an example, the untrained machine learning model comprises one or more matrix-parameterized layers; and the factorized machine learning model comprises one or more layers parameterized by a set of factorization matrices that is initialized using spectral initialization. In another example, the processed machine learning optimizer comprises a Frobenius decay function. In a further example, the indication further comprises a set of model processing rules. In yet another example, the set of operations further comprises: training, using a set of training data, the factorized machine learning model using the processed machine learning optimizer. In a further still example, the untrained machine learning model comprises at least one of: a convolutional layer; a fully connected layer; or a multi-head attention layer.

In a further aspect, the technology relates to a method of generating a factorized machine learning model. The method comprises: receiving, from a client device, an indication of an untrained machine learning model and an optimizer, wherein the untrained machine learning model comprises a layer that is parameterized by an initial matrix; factoring the initial matrix of the untrained machine learning model into a set of factorization matrices; initializing the set of factorization matrices using spectral initialization; generating a factorized machine learning model comprising the initialized set of factorization matrices in place of the initialization matrix; processing the optimizer to replace a weight decay function of a regularizer; and providing, to the client device, the factorized machine learning model and the processed optimizer. In an example, the weight decay function of the regularizer is replaced with a Frobenius decay function; and the initialized set of factorization matrices and the Frobenius decay function are associated with a factorized layer of the factorized machine learning model. In another example, the processed optimizer further comprises a weight decay function associated with a non-factorized layer of the factorized machine learning model. In a further example, the layer is one of: a convolutional layer; a fully connected layer; or a multi-head attention layer. In yet another example, the method further comprises: generating a set of model processing rules based at least in part on the received indication. In a further still example, the indication further comprises a set of model processing rules; and the initial matrix is factored based at least in part on the set of model processing rules. In another example, the indication further comprises a set of model processing rules; and the set of factorization matrices is initialized based at least in part on the set of model processing rules.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system comprising:
at least one processor; and
memory storing instructions that, when executed by the at least one processor, causes the system to perform a set of operations, the set of operations comprising:
processing a layer of an initial machine learning model to generate a factorized machine learning model;
processing, based at least in part on the factorized machine learning model, an optimizer associated with the machine learning model to generate a processed optimizer associated with the factorized machine learning model; and
training the factorized machine learning model using the processed optimizer.

2. The system of claim 1, wherein processing the layer of the initial machine learning model comprises:
factoring a matrix associated with the layer of the initial machine learning model into a set of factorization matrices; and
initializing the set of factorization matrices using spectral initialization.

3. The system of claim 1, wherein processing the optimizer comprises replacing a weight decay function of a regularizer with a Frobenius decay function.

4. The system of claim 3, wherein the processed optimizer further comprises a weight decay function associated with a non-factorized layer of the factorized machine learning model.

5. The system of claim 1, wherein the layer is one of:
a convolutional layer;
a fully connected layer; or
a multi-head attention layer.

6. The system of claim 1, wherein the initial machine learning model is processed to generate the factorized machine learning model based at least in part on a set of model processing rules.

7. The system of claim 2, wherein:
the layer of the initial machine learning model is a matrix-parameterized layer; and
the set of factorization matrices are based at least in part on the matrix-parameterized layer.

8. A system comprising:
at least one processor; and
memory storing instructions that, when executed by the at least one processor, causes the system to perform a set of operations, the set of operations comprising:
providing, to a server device, an indication of an untrained machine learning model and a machine learning optimizer;
receiving, from the server device, a factorized machine learning model and a processed machine learning optimizer; and
generating an inference using the trained factorized machine learning model.

9. The system of claim 8, wherein:
the untrained machine learning model comprises one or more matrix-parameterized layers; and
the factorized machine learning model comprises one or more layers parameterized by a set of factorization matrices that is initialized using spectral initialization.

10. The system of claim 8, wherein the processed machine learning optimizer comprises a Frobenius decay function.

11. The system of claim 8, wherein the indication further comprises a set of model processing rules.

12. The system of claim 8, wherein the set of operations further comprises:
training, using a set of training data, the factorized machine learning model using the processed machine learning optimizer.

13. The system of claim 8, wherein the untrained machine learning model comprises at least one of:
a convolutional layer;
a fully connected layer; or
a multi-head attention layer.

14. A method of generating a factorized machine learning model, the method comprising:
receiving, from a client device, an indication of an untrained machine learning model and an optimizer, wherein the untrained machine learning model comprises a layer that is parameterized by an initial matrix;
factoring the initial matrix of the untrained machine learning model into a set of factorization matrices;
initializing the set of factorization matrices using spectral initialization;
generating a factorized machine learning model comprising the initialized set of factorization matrices in place of the initialization matrix;
processing the optimizer to replace a weight decay function of a regularizer; and
providing, to the client device, the factorized machine learning model and the processed optimizer.

15. The method of claim 14, wherein:
the weight decay function of the regularizer is replaced with a Frobenius decay function; and
the initialized set of factorization matrices and the Frobenius decay function are associated with a factorized layer of the factorized machine learning model.

16. The method of claim 14, wherein the processed optimizer further comprises a weight decay function associated with a non-factorized layer of the factorized machine learning model.

17. The method of claim 14, wherein the layer is one of:
a convolutional layer;
a fully connected layer; or
a multi-head attention layer.

18. The method of claim 14, further comprising generating a set of model processing rules based at least in part on the received indication.

19. The method of claim 14, wherein:
the indication further comprises a set of model processing rules; and
the initial matrix is factored based at least in part on the set of model processing rules.

20. The method of claim 14, wherein:
the indication further comprises a set of model processing rules; and
the set of factorization matrices is initialized based at least in part on the set of model processing rules.
